(19) United States
(12) Patent Application Publication
(10) Pub. No.: US 2005/0256217 A1
(43) Pub. Date: Nov. 17, 2005

(54) Monoalkenyl aromatic polyblend

(76) Inventors: Michael J. Hanner, Marietta, OH (US); Chen-youn Sue, Williamstown, WV (US)

Correspondence Address: WILLIAMS, MORGAN & AMERSON, P.C., 10333 RICHMOND, SUITE 1100, HOUSTON, TX, 77042, US

(21) Appl. No.: 10/844,163

(22) Filed: May 12, 2004

(51) Int. Cl. C08J 9/00

(52) U.S. Cl. 521/142; 525/192

(57) ABSTRACT

Disclosed herein are polyblends comprising a first polymer and at least one rubber polymer dispersed as rubber grafted with the polymer. The polymer comprises at least one monoalkenyl aromatic monomer, and the polyblend comprises at least one monoalkenyl aromatic dimer, at least one monoalkenyl aromatic trimer, or a mixture thereof.

### FIELD OF THE INVENTION

The present invention generally relates to monoalkenyl aromatic polyblend compositions comprising dispersed rubber phase and their production. More specifically the invention relates to an improvement in the physical properties of the polyblend by the incorporation of monoalkenyl aromatic dimers, trimers, or mixtures thereof.

### BACKGROUND OF THE INVENTION

Monoalkenyl aromatic polyblend compositions comprising a dispersed rubber phase are known in the art. Polyblends or alloys are mixtures of two or more polymers. One type of monoalkenyl aromatic polyblend known in the art is a high impact polystyrene polyblend (HIPS) comprising rubber polymer particles, such as polybutadiene particles, phase dispersed in polystyrene. More specifically, HIPS is an immiscible polyblend, because the rubber and the polystyrene are phase separated. HIPS can be tougher and more ductile than unblended polystyrene. HIPS can have relatively good rigidity, good impact resistance, high heat resistance, good moldability, high melt flow, ignition resistance, and high environmental stress crack resistance (ESCR), when compared to certain other plastics. HIPS can be used for injection molding, injection blow molding and sheet extrusion, among others. Different types of HIPS products can be used in furniture, microfloppy diskettes, packaging, toys, electronic components, refrigerators, and air conditioners, among others.

HIPS can be produced by a continuous bulk polymerization method, among others. Continuous bulk polymerization can be performed by continuously feeding a starting material to a plurality of stirred tank reactors. The starting material can comprise styrene monomer and dissolved polybutadiene. During polymerization a two-phase system is formed due to the immiscibility of polystyrene and polybutadiene. Polystyrene forms the continuous phase and the polybutadiene forms the dispersed (non-continuous) phase. As is known in the art, the shape and particle size, and volume fraction of the dispersed phase of the polybutadiene significantly affects the properties of HIPS. As particle size of polybutadiene increases in HIPS, Izod impact strength can increase, tensile strength at yield can decrease, and elongation at break can increase up to a point and then can decrease. In some cases, other additives, such as fillers, coupling agents, and ultraviolet stabilizers, among others can be included in the polyblend. In some cases, mineral oil is added to the starting material to increase high tensile elongation of HIPS. However, mineral oil can adversely affect the flow and heat distortion properties of HIPS.

It would be desirable to be able to find new methods of improving tensile elongation and Izod impact strength of monoalkenyl aromatic polyblends.

### SUMMARY OF THE INVENTION

One aspect of the present invention is directed to polyblend compositions that can comprise a first polymer and at least one rubber polymer that can be dispersed within the first polymer. The rubber can exist as crosslinked particles grafted to the first polymer. The polyblend compositions can comprise less than about 1.5 wt % blowing agent based on the weight of the first polymer. The first polymer can comprise at least one monoalkenyl aromatic monomer, and can have a M_{w} (weight average molecular weight) of less than about 249,000 amu. The polyblend can further comprise at least one monoalkenyl aromatic dimer, at least one monoalkenyl aromatic trimer, or a mixture thereof. In some embodiments, the composition can comprise up to about 15,000 parts per million by weight (ppm) of the monoalkenyl aromatic dimer, the monoalkenyl aromatic trimer, or the mixture thereof. In some embodiments, the dimer and trimer can be styrene dimers and trimers, and the polymer can be polystyrene. In certain embodiments, the rubber polymer can be polybutadiene. In some aspects of the invention, the polyblend composition can consist essentially of (a) the first polymer, (b) the rubber polymer, and (c) the monoalkenyl aromatic dimer, the monoalkenyl aromatic trimer, or the mixture of the dimer and the trimer.

Certain embodiments of the present invention are directed to methods of preparing polyblend compositions, as described above, that can comprise polymerizing at least one monoalkenyl aromatic monomer, in the presence of (a) at least one rubber polymer, and (b) at least one monoalkenyl aromatic dimer, at least one monoalkenyl aromatic trimer or a mixture thereof. The polyblend composition, in some embodiments, can comprise up to about 15,000 ppm of the monoalkenyl aromatic dimer, the monoalkenyl aromatic trimer, or the mixture thereof. In some embodiments, the monoalkenyl aromatic dimer, the monoalkenyl aromatic trimer or the mixture thereof can be provided as components of a feed stream that comprises between about 0.2 wt % and 3.5 wt % of the dimer, the trimer, or the mixture thereof. In certain embodiments, the monoalkenyl aromatic dimer, the monoalkenyl aromatic trimer or the mixture thereof can be components of a distillate from a second independent polymerization of at least one monoalkenyl aromatic monomer.

Another aspect of the present invention is directed to systems for the production of a polyblend composition. The system can comprise a polyblend production vessel, and first, second and third feed lines. The first feed line can supply a first stream comprising (a) at least one dimer of at least one first monoalkenyl aromatic monomer, (b) at least one trimer of at least one first monoalkenyl aromatic monomer, or (c) a mixture thereof to the polyblend production vessel. The second feed line can supply a second stream comprising at least one second monoalkenyl aromatic monomer to the polyblend production vessel, and the third feed line can supply a third stream comprising at least one rubber polymer to the polyblend production vessel. In some embodiments, the system can further comprise a polymerization vessel used in a thermal polymerization of the at least one first monoalkenyl aromatic monomer, wherein the polymerization vessel is coupled to a distillate recovery vessel. The first feed line can connect the distillate recovery vessel to the polyblend production vessel, in certain embodiments. In some embodiments the first monoalkenyl aromatic monomer and the second monoalkenyl aromatic monomer can be styrene, and the rubber polymer can be a polybutadiene.

### BRIEF DESCRIPTION OF DRAWINGS

FIG. 1 is a process flow diagram of one embodiment of a process of the present invention.

FIG. 2 is a graph of rubber syrup dimer/trimer composition in various compositions of the present invention.

FIG. 3 is a graph of melt flow rate (MFR) of HIPS 1, a first sample of HIPS, before distillate addition. The average MFR was 315 mg/minute, the maximum was 341 mg/minute, and the minimum was 288 mg/minute.

FIG. 4 is a graph of melt flow rate (MFR) of HIPS 1 after distillate addition. The average MFR was 319 mg/minute, the maximum was 358 mg/minute, and the minimum was 292 mg/minute.

FIG. 5 is a graph of MFR of HIPS 2, a second sample of HIPS, before distillate addition. The average MFR was 300 mg/minute, the maximum was 326 mg/minute, and the minimum was 271 mg/minute.

FIG. 6 is a graph of MFR of HIPS 2 after addition of distillate. The average MFR was 299 mg/minute, the maximum was 339 mg/minute, and the minimum was 268 mg/minute.

FIG. 7 is a graph of MFR of HIPS 3 before addition of distillate. The average MFR was 277 mg/minute, the maximum was 310 mg/minute, and the minimum was 256 mg/minute.

FIG. 8 is a graph of MFR of HIPS 3 after addition of the distillate. The average MFR was 289 mg/minute, the maximum was 305 mg/minute, and the minimum was 272 mg/minute.

FIG. 9 is a graph of MFR of HIPS 4 before addition of distillate. The average MFR was 176 mg/minute, the maximum was 191 mg/minute, and the minimum was 163 mg/minute.

FIG. 10 is a graph of MFR of HIPS 4 after addition of distillate. The average MFR was 181 mg/minute, the maximum was 205 mg/minute, and the minimum was 165 mg/minute.

FIG. 11 is a graph of Vicat of HIPS 1 before addition of distillate. The average Vicat was 214° F., the maximum was 215° F., and the minimum was 213° F.

FIG. 12 is a graph of Vicat of HIPS 1 after addition of distillate. The average Vicat was 213° F., the maximum was 214° F., and the minimum was 211° F.

FIG. 13 is a graph of Vicat of HIPS 2 before addition of distillate. The average Vicat was 215° F., the maximum was 215° F., and the minimum was 214° F.

FIG. 14 is a graph of Vicat of HIPS 2 after addition of distillate. The average Vicat was 213° F., the maximum was 214° F., and the minimum was 213° F.

FIG. 15 is a graph of Vicat of HIPS 3 before addition of distillate. The average Vicat was 215° F., the maximum was 215° F., and the minimum was 215° F.

FIG. 16 is a graph of Vicat of HIPS 3 after addition of distillate. The average Vicat was 215° F., the maximum was 215° F., and the minimum was 214° F.

FIG. 17 is a graph of Vicat of HIPS 4 before addition of distillate. The average Vicat was 220° F., the maximum was 222° F., and the minimum was 220° F.

FIG. 18 is a graph of Vicat of HIPS 4 after addition of distillate. The average Vicat was 219° F., the maximum was 220° F., and the minimum was 218° F.

FIG. 19 is a graph of percent tensile elongation of HIPS 1 before addition of distillate. The average percent tensile elongation was 82%, the maximum was 95%, and the minimum was 74%.

FIG. 20 is a graph of percent tensile elongation of HIPS 1 after addition of distillate. The average percent tensile elongation was 94%, the maximum was 111%, and the minimum was 77%.

FIG. 21 is a graph of percent tensile elongation of HIPS 2 before addition of distillate. The average percent tensile elongation was 76%, the maximum was 85%, and the minimum was 67%.

FIG. 22 is a graph of percent tensile elongation of HIPS 2 after addition of distillate. The average percent tensile elongation was 71%, the maximum was 81%, and the minimum was 66%.

FIG. 23 is a graph of percent tensile elongation of HIPS 4 before addition of distillate. The average percent tensile elongation was 41%, the maximum was 50%, and the minimum was 32%.

FIG. 24 is a graph of percent tensile elongation of HIPS 4 after addition of distillate. The average percent tensile elongation was 50%, the maximum was 71%, and the minimum was 38%.

FIG. 25 is a graph of percent tensile elongation of HIPS 3 before addition of distillate. The average percent tensile elongation was 69%, the maximum was 80%, and the minimum was 61%.

FIG. 26 is a graph of percent tensile elongation of HIPS 3 after addition of distillate. The average percent tensile elongation was 72%, the maximum was 85%, and the minimum was 63%.

### DESCRIPTION OF ILLUSTRATIVE EMBODIMENTS

Certain embodiments of the present invention are directed to polyblend compositions comprising (a) a first polymer comprising at least one monoalkenyl aromatic monomer, and having a M_{w} less than about 249,000 amu, (b) at least one monoalkenyl aromatic dimer, at least one monoalkenyl aromatic trimer, or a mixture thereof, and (c) at least one rubber polymer, wherein the rubber polymer is dispersed within the first polymer. The rubber polymer can be crosslinked rubber particles grafted to the first polymer, in some embodiments. The dimers and trimers are free compounds, and are not part of the first polymer. Polyblend compositions comprising a polymer comprising at least one monoalkenyl aromatic monomer and at least one rubber polymer that is dispersed as rubber particles within the polymer are known in the art, for example HIPS, among others. Such compositions and methods of their production are taught by U.S. Pat. Nos. 4,214,056; 4,857,587; 4,952,627; 5,256,732; 5,349,012; 5,663,318; and 5,985,997; which are incorporated herein by reference.

In certain embodiments, the monoalkenyl aromatic monomer of the first polymer can have formula I 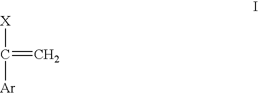
wherein Ar can be an aromatic group comprising 6 to 14 carbon atoms, and X can be selected from hydrogen or an alkyl radical having less than three carbon atoms. In certain embodiments, the aromatic group comprises at least one of a phenyl group, a halo-phenyl group, an alkylphenyl group, or an alkylhalophenyl group. In certain embodiments the monoalkenyl aromatic monomer can be styrene, alpha-methylstyrene, alpha-ethylstyrene, alpha-methylvinyltoluene, vinyl toluene, o-ethylstyrene, p-ethylstyrene, 2,4-dimethylstyrene, t-butylstyrene, o-chlorostyrene, p-chlorostyrene, o-bromostyrene, 2,4-dichlorostyrene, 2-chloro-4-methylstyrene, or 2,6-dichloro-4-methylstyrene. In some embodiments, the monoalkenyl aromatic monomer can be styrene. The first polymer can have a M_{w} of less than about 249,000 amu in some embodiments, and of between about 220,000 amu and 249,000 amu in certain embodiments. In some embodiments of the invention, the first polymer has a M_{w} of less than about 245,000 amu.

The rubber polymer can be polybutadiene, polyisoprene, poly2-chloro-1,3-butadiene, poly1-chloro-1,3-butadiene, styrene/butadiene copolymer, styrene/butadiene/styrene block copolymer, ethylene/propylene terpolymer, butadiene/acrylonitrile copolymer, butyl rubber, acrylic rubber, styrene/isobutylene/butadiene copolymer, or isoprene/acrylic ester copolymer or mixtures thereof, in certain embodiments. In some embodiments, the rubber polymer can be a diene rubber. In certain embodiments, the rubber polymer can be polybutadiene.

In some embodiments, the at least one monoalkenyl aromatic dimer, at least one monoalkenyl aromatic trimer, or a mixture thereof can be components of a recovered distillate from a thermal polymerization of monoalkenyl aromatic monomer process, such as a styrene polymerization process, among others. In certain embodiments the distillate can be recovered from a flash vessel. In some embodiments, the distillate can comprise styrene monomer, styrene dimer, styrene trimer, and toluene or ethyl benzene. The rubber polymer can be polybutadiene and the monoalkenyl aromatic monomer can be styrene, the dimer can be a styrene dimer, and the trimer can be a styrene trimer, in some embodiments. In certain embodiments, the polyblend composition can comprise up to about 15,000 ppm of the monoalkenyl aromatic dimer, the monoalkenyl aromatic trimer, or the mixture thereof. In certain embodiments the polyblend composition produced by this method can comprise at least about 650 ppm, at least about 700 ppm, of the monoalkenyl aromatic dimer. In certain embodiments the polyblend composition produced by this method can comprise at least about 8500 ppm, at least about 9000 ppm, of the monoalkenyl aromatic trimer. In certain embodiments the polyblend composition produced by this method can comprise about 650 ppm to about 6,500 ppm of the monoalkenyl aromatic dimer. In certain embodiments the polyblend composition produced by this method about 8,500 ppm to about 14,000 ppm of the monoalkenyl aromatic trimer. In certain embodiments the polyblend composition produced by this method can comprise about 650 ppm to about 6,500 ppm of the monoalkenyl aromatic dimer and about 8,500 ppm to about 14,000 ppm of the monoalkenyl aromatic trimer.

In certain embodiments, the polyblend compositions comprise less than about 1.5 wt % of blowing agent based on the weight of the first polymer. In some embodiments, the polyblend compositions comprise less than about 1 wt %, and in still other embodiments less than about 0.5 wt % of blowing agent. In other embodiments, the polyblend compositions comprise essentially no (e.g., less than about 0.1 wt %) blowing agent. “Blowing agent”, as used herein, refers to chemicals that are mixed into a polymeric material which produce a gas thereby generating gas pockets, “cells”, in the polymeric material to form a cellular structure. Exemplary blowing agents are physical blowing agents, which form a gas by a phase change, and chemical blowing agents, which form a gas by decomposition. It is known in the art that greater than about 2 wt % of blowing agent is required in a polyblend material to make it heat expandable. In some embodiments, the polyblend compositions can have an Izod impact strength of between about 1.5 ft.lb/inch and 5.0 ft.lb/inch, and in certain embodiments between about 1.8 ft.lb/inch and 2.5 ft.lb/inch. The polyblend compositions can have a tensile strength of between about 1500 psi and 5500 psi. In some embodiments the polyblend compositions can have a tensile strength of between about 200 psi and 4500 psi. In some embodiments, the polyblend composition can have a tensile elongation of between about 30% and 120%, and in other embodiments, between about 50% and 90%. In some aspects, the polyblend compositions can have a Vicat heat distortion between about 205° F. and 220° F., and in other aspects between about 210° F. and 215° F. The compositions can have a melt flow rate between about 150 mg/minute and 1500 mg/minute, and in some embodiments between about 200 mg/minute and 600 mg/minute.

The polyblend compositions of the present invention can, in certain embodiments, comprise additives such as antiblocking agents, antistatic agents, heat stabilizers, ultraviolet stabilizers, biocides, antioxidants, lubricants, slip agents, mold release agents, colorants, plasticizers, dyes, pigments, and flame retardants, as well as fillers and reinforcing agents, such as minerals, metallic powders, glass and glass fibers.

Certain embodiments of the present invention are directed to methods of preparing the compositions described above. The methods comprise polymerizing at least one monoalkenyl aromatic monomer, in the presence of at least one rubber polymer and (a) at least one monoalkenyl aromatic dimer, (b) at least one monoalkenyl aromatic trimer or (c) a mixture thereof, wherein the polyblend composition comprises a polymer comprising at least one monoalkenyl aromatic monomer and having a M_{w} of less than about 249,000 amu, at least one monoalkenyl aromatic dimer, at least one monoalkenyl aromatic trimer, or a mixture thereof, and at least one rubber polymer, wherein the rubber polymer is dispersed within the first polymer. The dimer and trimer in the polyblend are not part of the first polymer.

The polyblend composition produced by this method can comprise up to about 15,000 ppm of the monoalkenyl aromatic dimer, the monoalkenyl aromatic trimer, or the mixture thereof. In certain embodiments the polyblend composition produced by this method can comprise at least about 650 ppm, at least about 700 ppm, of the monoalkenyl aromatic dimer. In certain embodiments the polyblend composition produced by this method can comprise at least about 8,500 ppm, at least about 9,000 ppm, of the monoalkenyl aromatic trimer. In certain embodiments the polyblend composition produced by this method can comprise about 650 ppm to about 6,500 ppm of the monoalkenyl aromatic dimer. In certain embodiments the polyblend composition produced by this method about 8,500 ppm to about 14,000 ppm of the monoalkenyl aromatic trimer. In certain embodiments the polyblend composition produced by this method can comprise about 650 ppm to about 6,500 ppm of the monoalkenyl aromatic dimer and about 8,500 ppm to about 14,000 ppm of the monoalkenyl aromatic trimer. In certain embodiments, the monoalkenyl aromatic dimer, the monoalkenyl aromatic trimer or the mixture thereof can be components of a feed stream that comprises between about 0.2 wt % and 3.5 wt % of the monoalkenyl aromatic dimer, the monoalkenyl aromatic trimer, or the mixture thereof, in some embodiments between about 0.2 wt % and 3.0 wt %, and in still other embodiments between about 0.2 wt % and 2.5 wt %. In certain embodiments, the monoalkenyl aromatic dimer, the monoalkenyl aromatic trimer or the mixture thereof can be components of a distillate from a second independent polymerization of at least one monoalkenyl aromatic monomer. The monomer can be as described above, in some embodiments. In certain aspects, the rubber used in the method can be as described above. The composition and properties of the polyblend composition produced can be as described above, in certain embodiments.

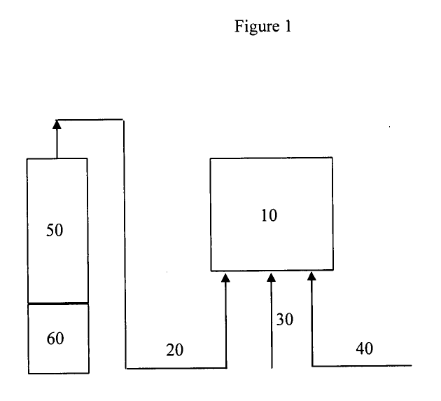

Certain embodiments of the present invention are directed to systems for the production of a polyblend and can be better understood by reference to FIG. 1. The system can comprise a polyblend production vessel 10; a first feed line 20 that supplies a first stream comprising (a) at least one dimer of at least one first monoalkenyl aromatic monomer, (b) at least one trimer of at least one first monoalkenyl aromatic monomer, or (c) a mixture thereof to the polyblend production vessel; a second feed line 30 that supplies a second stream comprising at least one second monoalkenyl aromatic monomer to the polyblend production vessel; and a third feed line 40 that supplies a third stream comprising at least one rubber polymer dissolved in a solvent comprising monoalkenyl aromatic monomer to the polyblend production vessel.

Optionally, the system can further comprise a polymerization 60 vessel used in a thermal polymerization of the at least one first monoalkenyl aromatic monomer, wherein the polymerization vessel can be coupled to a distillate recovery vessel (e.g., flash vessel) 50, and the first feed line 20 connects the flash vessel to the polyblend production vessel 10. The flash vessel 50 permits volatiles and some portions of dimers, trimers to vaporize rapidly under vacuum and elevated temperatures from a polymer melt. The polymer melt has unconverted monomers and byproducts of the polymerization reactions. Solvents can also be present in the polymer melt. There can also be impurities from the monomer feeds in the distillates. The flash vessel distillates are condensates of the vaporized volatiles and dimers, trimers from the flash vessel. When the polymerization is used to produce polystyrene the distillates can comprise styrene monomer with minor portions of toluene, ethylbenzene, dimers, trimers, xylenes, cumene, and propylbenzene.

In some embodiments, the first stream 20 can further comprise toluene. Optionally, the first monoalkenyl aromatic monomer and the second monoalkenyl aromatic monomer can be the same monomer. The first monoalkenyl aromatic monomer and the second monoalkenyl aromatic monomer can be styrene, in some embodiments. In some embodiments, the rubber polymer can be polybutadiene. In certain embodiments, the rubber polymer can be supplied as a solution of rubber by dissolving rubber in the the second monoalkenyl aromatic monomer.

The following examples are included to demonstrate embodiments of the invention. It should be appreciated by those of skill in the art that the techniques disclosed in the examples which follow represent techniques discovered by the inventor to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

ASTM methods were applied to all property tests for resin samples of the examples, unless stated otherwise. MFR is the melt flow rate of the resin samples, and was measured at 200° C. under 5 kg weight load according to ASTM D1238. Melt flow data is reported in units of mg/min. Tensile strength at yield (Ty) and tensile elongation (TE) at break were measured according to ASTM D638 for the extruded samples of the polymer resins. Vicat is a softening temperature or a softening point at which a polymer can no longer support a useful load with time. Vicat was measure according to ASTM D1525, rate B, using molding samples of ¼″ thickness bars. Notched Izod is a measurement of impact resistance for polymers and was determined according to ASTM D256 method at room temperature using ⅛″ molded bars. The weight average molecular weight (Mw) and the number average molecular weight (Mn) and molecular weight distributions were determined by gel permeation chromatography (GPC) in tetrahydrofuran using polystyrene standards.

Certain flash vessel distillates from a thermal polymerization of styrene monomer process were added to a polybutadiene rubber syrup feed for HIPS production. It is known that the polystyrene polymerization by thermal initiation results in production of dimers and trimers as the by-products of the reaction, and these can be found in the distillate along with styrene and toluene. The distillates can comprise about 97 wt % volatile portion and about 3 wt % of a relatively less volatile portion. For the volatile portion, about 90 to 95 wt % can be unconverted styrene, about 3 to 5 wt % toluene, and less than about 0.5 wt % of ethyl benzene, xylenes, cumene and propylbenzene. For the less volatile portion, the trimers to dimers are present in about a 10 to 1 ratio.

Composition of the Distillates Used and Dimer/Trimer Data

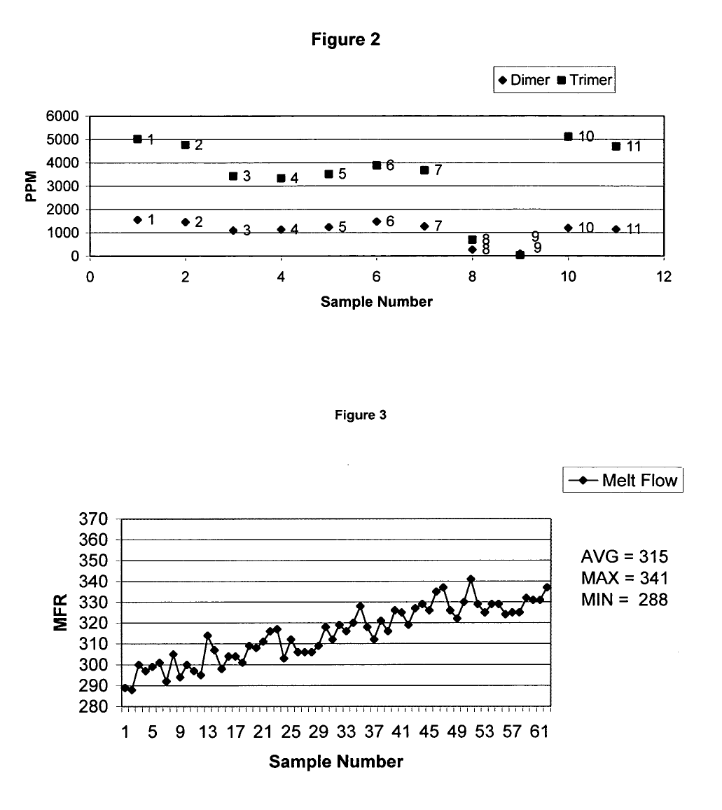

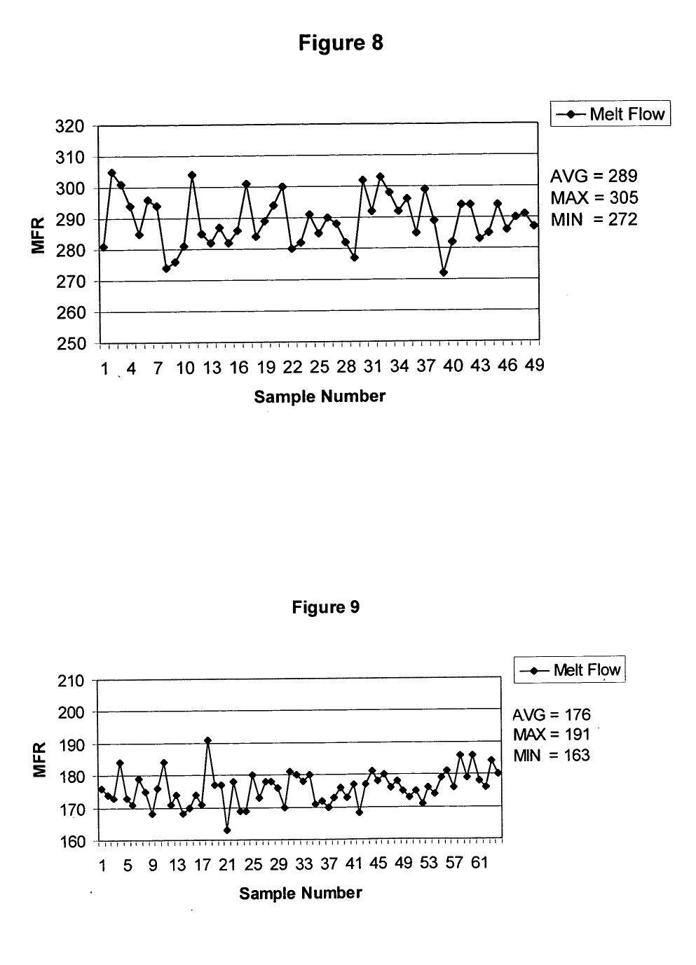

When the distillates were introduced into the rubber syrup, tests for polymer contents in the distillates were conducted using the methanol precipitation method that is known in the art. Results indicated that polystyrene polymer was present at a level below 500 ppm to 1000 ppm. However, gas chromatography (GC) and residual analysis of distillates indicated that there was a portion of about 2 to 3% by weight of heavy organic liquid in the distillates. Further analysis showed that the liquid was a mixture of styrene dimers and styrene trimers. FIG. 2 shows the dimer and trimer levels in certain samples of the rubber syrup. The distillates were the only source for introduction of dimers and trimers to the rubber syrup. The level of dimer in the syrups was found to be between about 1000 ppm and about 1800 ppm. The level of trimer in the syrups was found to be between about 3200 ppm and about 5000 ppm. When the distillates were not used in the rubber syrup, there was a drop in both dimer and trimer levels (FIGS. 8 and 9).

Tables 1 and 2 show the dimer/trimer volatile and residual material compositions of seven distillates tested. The dimer/trimer data were obtained using two different tests. In one test, the distillates were run directly on a gas chromatograph (GC) to determine dimer and trimer content. In the other test, the distillates were placed in an oven under vacuum at either 60° C. or 80° C. for one hour, before the residual material was weighed and analyzed by GC for dimers and trimers.

TABLE 1
Distillates Composition Data (Volatile Portion)

| | | | Ethyl | | | | n-Propyl | Color, |
|---|---|---|---|---|---|---|---|---|
| No. | Styrene % | Toluene % | Benzene % | m.p-Xylene % | o-Xylene % | Cumene % | Benzene % | unit |
| 1 | 94.2 | 5.5 | 0.01 | 0.12 | 0.07 | 0.05 | 0.03 | slight |
| | | | | | | | | blue |
| | | | | | | | | tint |
| 2 | 94.1 | 5.7 | 0.01 | 0.12 | 0.07 | 0.05 | 0.03 | slight |
| | | | | | | | | blue |
| | | | | | | | | tint |
| 3 | 94.9 | 4.9 | 0.01 | 0.08 | 0.06 | 0.04 | 0.03 | slight |
| | | | | | | | | blue |
| | | | | | | | | tint |
| 4 | 95.2 | 4.6 | 0.01 | 0.05 | 0.06 | 0.06 | 0.04 | slight |
| | | | | | | | | blue |
| | | | | | | | | tint |
| 5 | 94.7 | 5.1 | 0 | 0.03 | 0.06 | 0.05 | 0.03 | slight |
| | | | | | | | | blue |
| | | | | | | | | tint |
| 6 | 94.8 | 5.1 | 0 | 0.03 | 0.06 | 0.05 | 0.03 | slight |
| | | | | | | | | blue |
| | | | | | | | | tint |
| 7 | 94.8 | 5.1 | 0 | 0.02 | 0.06 | 0.05 | 0.03 | slight |
| | | | | | | | | blue |
| | | | | | | | | tint |

Note:
Data by GC for the volatile portion of the distillates only

TABLE 2
Distillates Dimer/Trimer Data (Residual Portion)

| | Dimer % | Trimer % | Dimer % | Trimer % | Dimer % | Trimer % |
|---|---|---|---|---|---|---|
| No. | GC | GC | oven 60° C. | oven 60° C. | oven 80° C. | oven 80° C. |
| 1 | 0.67 | 2.00 | 0.43 | 1.64 | 0.17 | 1.66 |
| 2 | 0.76 | 2.58 | 0.22 | 2.02 | 0.08 | 2.03 |
| 3 | 0.58 | 1.66 | 0.1 | 1.30 | 0.1 | 1.27 |
| 4 | 0.55 | 1.52 | 0.05 | 1.23 | 0.07 | 1.18 |
| 5 | 0.56 | 1.57 | 0.13 | 1.37 | 0.03 | 1.28 |
| 6 | 0.55 | 1.50 | 0.09 | 1.31 | 0.06 | 1.28 |
| 7 | 0.55 | 1.58 | 0.13 | 1.30 | 0.04 | 1.26 |

In the volatile portion of the distillates, styrene and toluene were the major components (styrene at about 95% and toluene at about 5%). Xylenes, cumene, ethyl benzene and propylbenzene were at less than about 0.3%. In all of the distillates, dimer was at a level less than about 0.5 wt % and trimer was at a level less than about 1.5 wt %. The polymer level in the distillates was between about 400 to 1000 ppm. The dimer and trimer level found in the rubber syrup after addition of the distillate was about one quarter of the levels in the distillates. This was consistent with the fact that the distillates accounted for about one quarter of the styrene used for the rubber syrup.

Dimer/Trimer and HIPS Properties

Melt Flow Rate

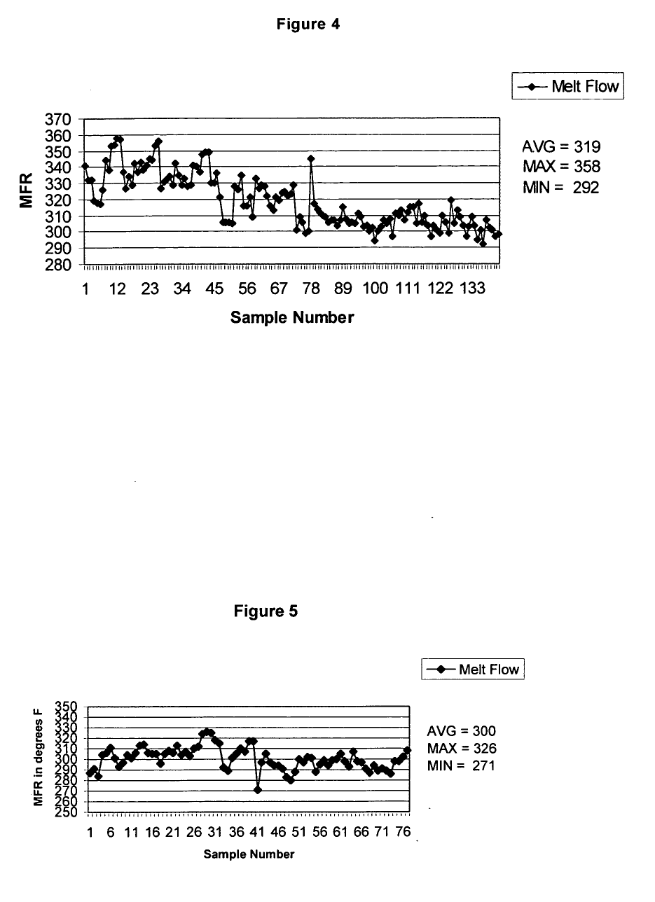

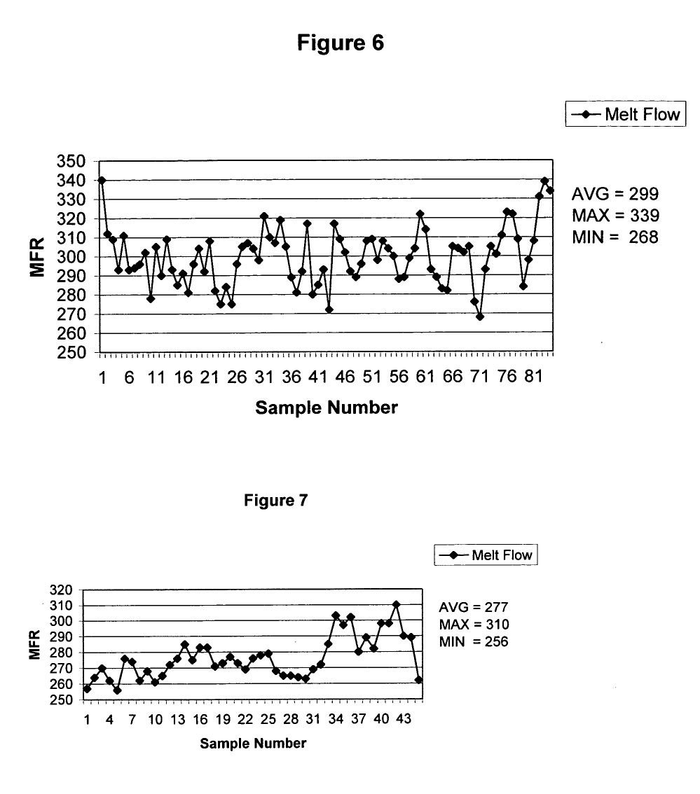

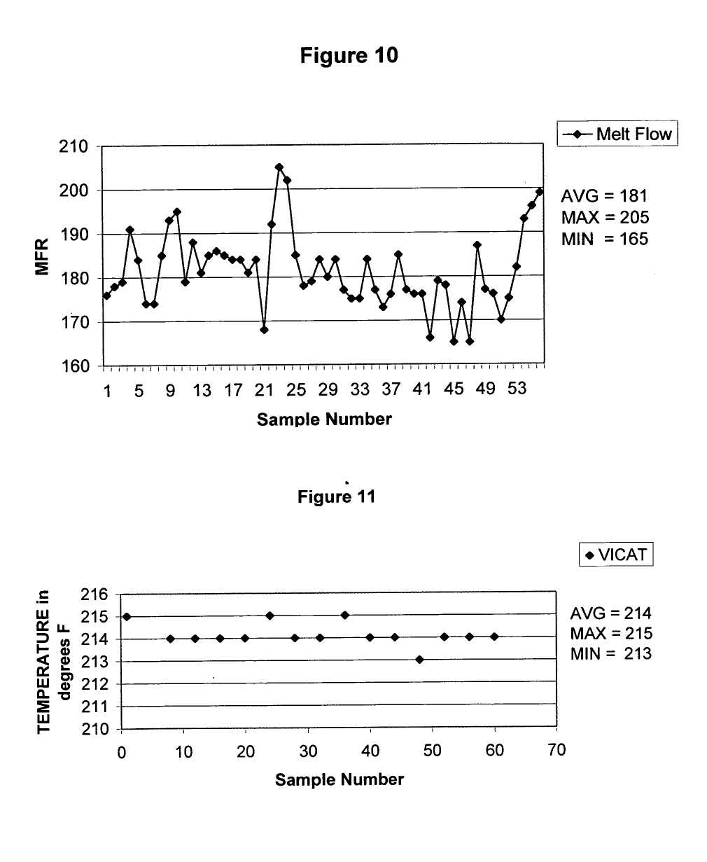

Initially direct use of distillates in the rubber syrup resulted in higher melt flow rates (MFR) for the HIPS products than the values for HIPS products which were produced without the distillate. As shown in FIGS. 3 to 10 for products HIPS 1, HIPS 2, HIPS 3 and HIPS 4, different sample runs of HIPS, before and after the direct use of distillates, the MFRs for HIPS with the distillates were higher than the values for HIPS without the distillates. The dimers and trimers may serve as plasticizers and increase the MFR of the HIPS.

Vicat

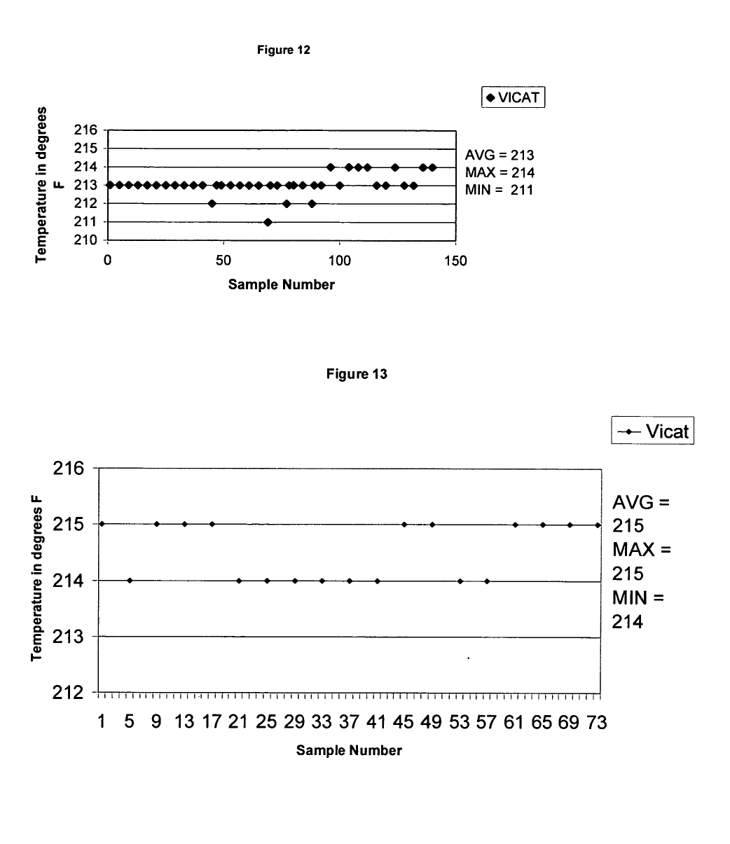

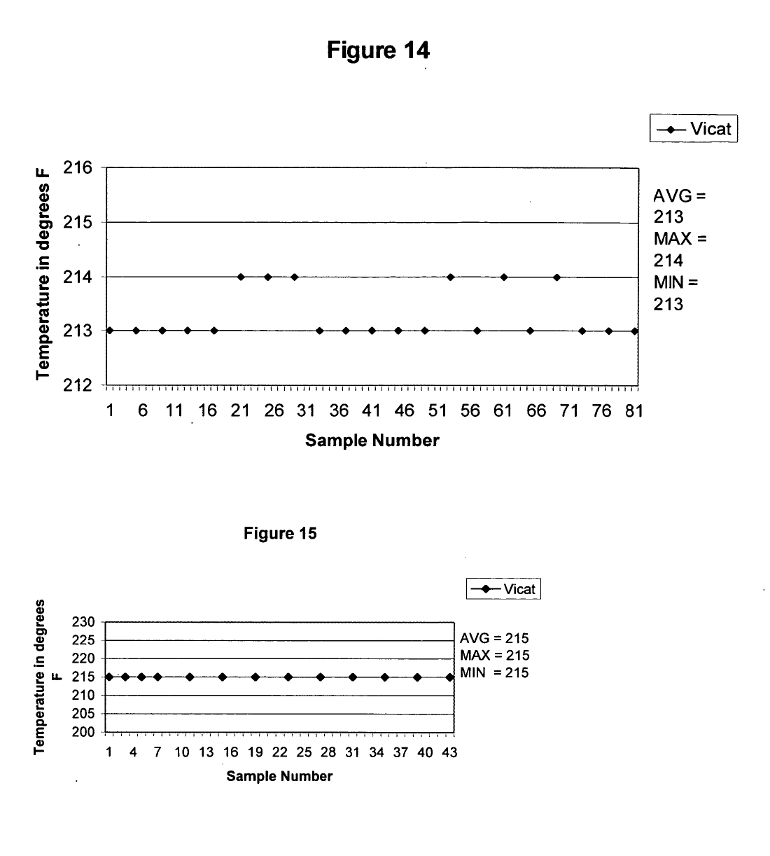

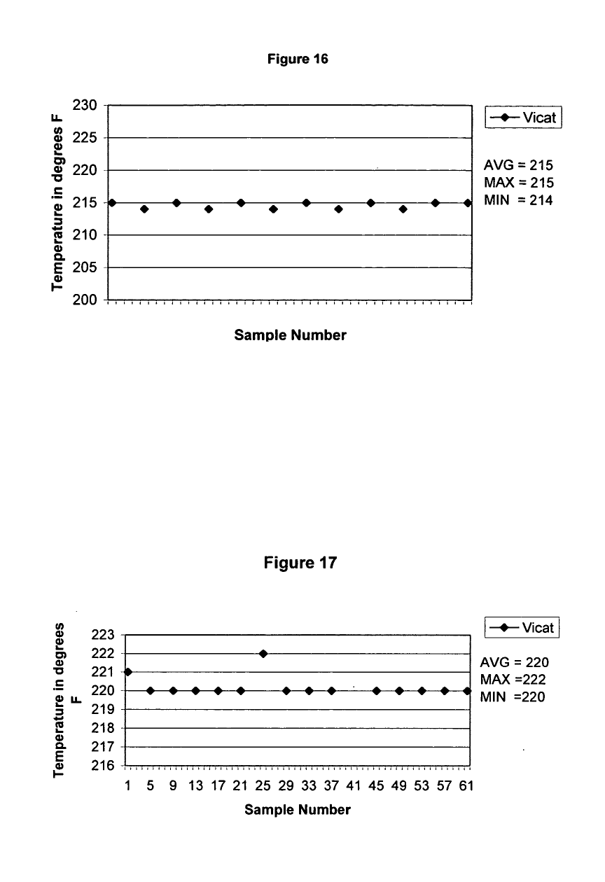

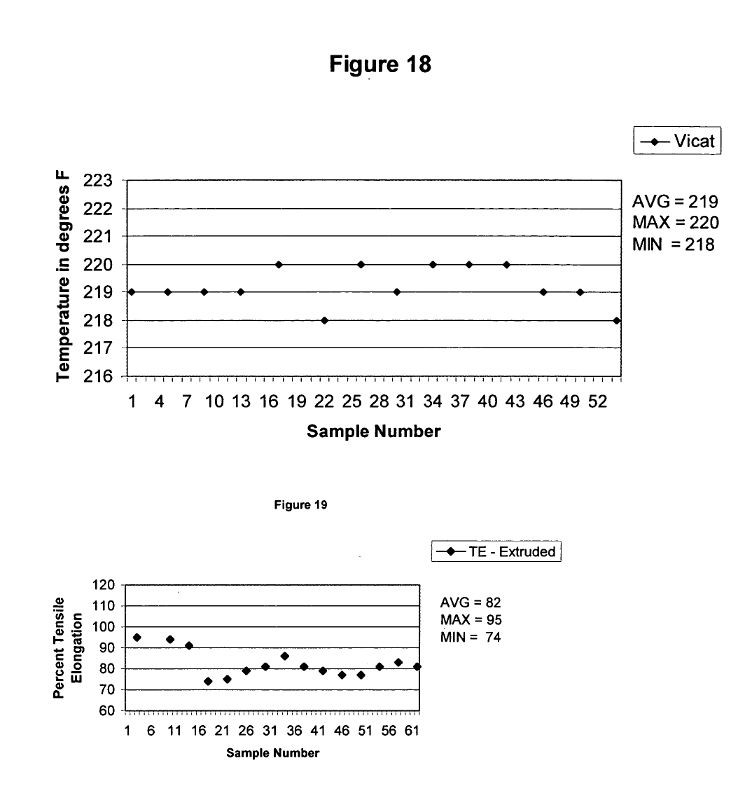

Vicat values (° F.) are shown in FIGS. 11 to 18 for HIPS 1, HIPS 2, HIPS 3 and HIPS 4 before and after the direct use of distillates. In general, increase in dimers and trimers resulted in a decrease in Vicat. As shown in these figures, there was about a one to two degree Fahrenheit drop for HIPS when distillates were used when compared with the Vicat of HIPS produced without using the distillates. This indicated that higher levels of dimers/trimers, particularly trimers, result in a more plasticizing effect on the rigid polystyrene, leading to a lower softening point.

Tensile Elongation

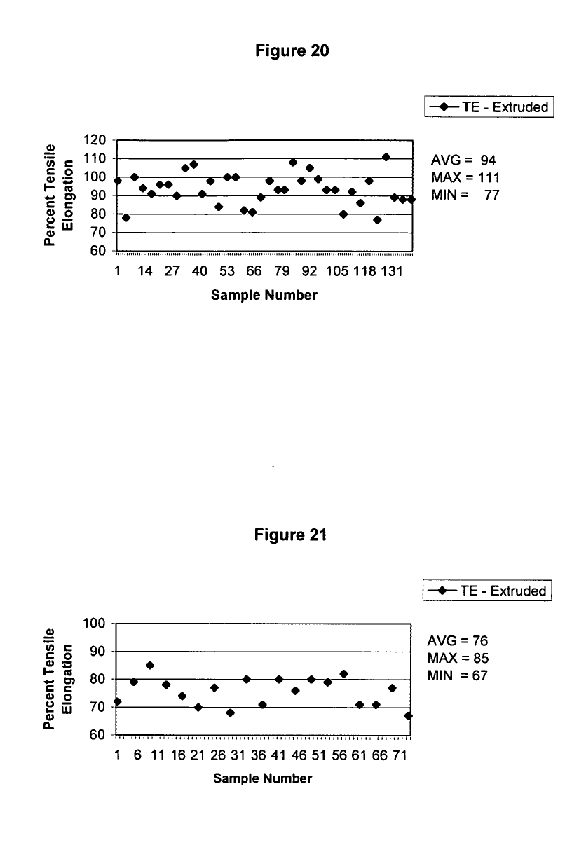

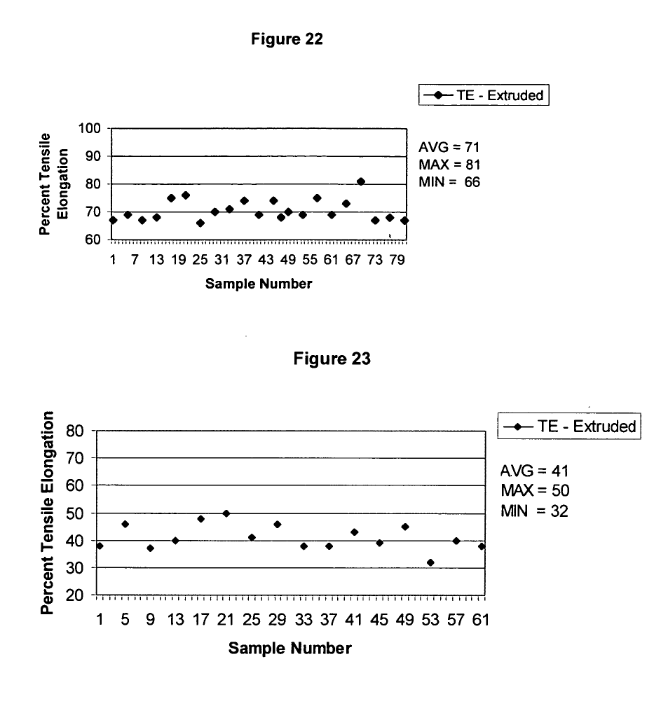

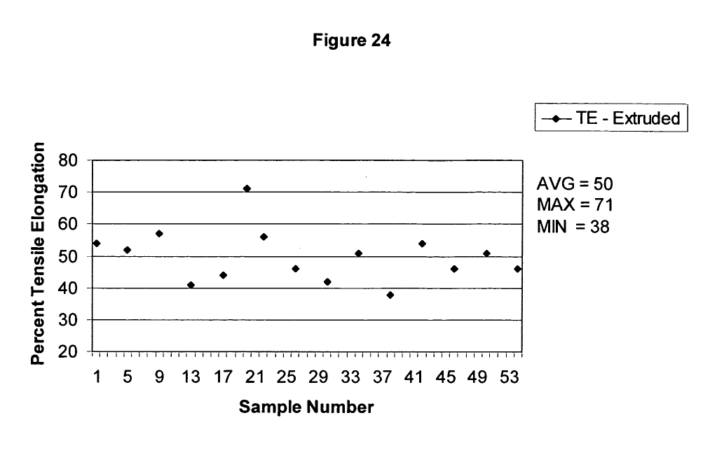

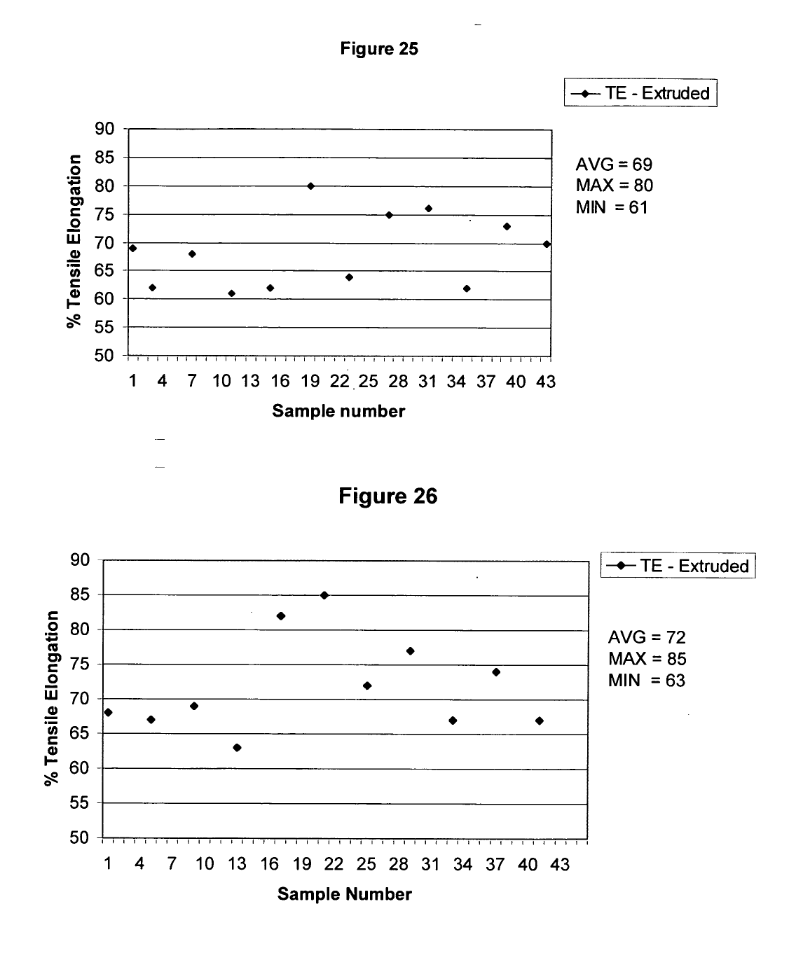

FIGS. 19 to 26 show tensile elongation data for HIPS 1, HIPS 2, HIPS 3 and, HIPS 4 before and after the direct use of distillates. The tensile elongation increased by a different degree for each HIPS product from a few percentage points to more than 10 percentage points, except for HIPS 2. This was because the amount of rubber used for HIPS 2 after the direct use of the distillates was lower than that for the HIPS 2 without the distillates, by a few percentage points. However, this seems to show that the rubber level was still an important factor in determining the tensile elongation property of the HIPS. The plasticizing effect of dimers/trimers was one factor resulting in the enhancement of the tensile elongation.

Analytical data demonstrate that significant amounts of dimers/trimers were removed from the polymer mixture in the flash vessel in the distillate. The dimers/trimers were about 2% of the total distillates from the flash vessel. The ratio of dimer to trimer was about 1 to 10 by weight in the distillate. Part of the dimers/trimers were removed after the devolatilization stage. Another part of the dimers/trimers stayed in the finished polymer resin.

The direct use of distillates introduced an additional amount of dimer/trimer to the rubber syrup along with some toluene and other impurities. The resulting HIPS products had certain property improvements, such as in melt flow and tensile elongation. These property changes indicate that dimers/trimers acted as a plasticizer for polystyrene.

All of the compositions and methods disclosed and claimed herein can be made and executed without undue experimentation in light of the present disclosure. While the compositions and methods of this invention have been described in terms of certain embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

1. A polyblend composition comprising:
a first polymer comprising at least one monoalkenyl aromatic monomer and having a weight average molecular weight (Mw) less than about 249,000 amu,
at least one monoalkenyl aromatic dimer, at least one monoalkenyl aromatic trimer, or a mixture thereof,
at least one rubber polymer, wherein the rubber polymer is dispersed within the first polymer,
wherein the polyblend composition comprises at least about 650 ppm of the monoalkenyl aromatic dimer, and
wherein the polyblend composition comprises less than about 1.5 wt % blowing agent based on the weight of first polymer.

2. The composition of claim 1, wherein the monoalkenyl aromatic monomer has a formula I 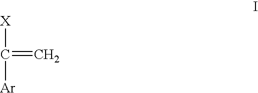
wherein Ar is an aromatic group comprising at least one of a phenyl group, a halo-phenyl group, an alkylphenyl group, or an alkylhalophenyl group, and X is selected from hydrogen or an alkyl radical having less than three carbon atoms.

3. The composition of claim 1, wherein the monoalkenyl aromatic monomer is styrene, alpha-methylstyrene, alpha-ethylstyrene, alpha-methylvinyltoluene, vinyl toluene, o-ethylstyrene, p-ethylstyrene, 2,4-dimethylstyrene, t-butylstyrene, o-chlorostyrene, p-chlorostyrene, o-bromostyrene, 2,4-dichlorostyrene, 2-chloro-4-methylstyrene, 2,6-dichloro-4-methylstyrene, or a mixture thereof.

4. The composition of claim 1, wherein the monoalkenyl aromatic monomer is styrene.

5. The composition of claim 1, wherein the M_{w} of the first polymer is less than about 245,000 amu.

6. The composition of claim 1, wherein the M_{w} of the first polymer is between about 220,000 amu and 249,000 amu.

7. The composition of claim 1, wherein the rubber polymer is polybutadiene, polyisoprene, poly2-chloro-1,3-butadiene, poly1-chloro-1,3-butadiene, styrene/butadiene copolymer, styrene/butadiene/styrene block copolymer, ethylene/propylene terpolymer, butadiene/acrylonitrile copolymer, butyl rubber, acrylic rubber, styrene/isobutylene/butadiene copolymer, isoprene/acrylic ester copolymer, or a mixture thereof.

8. The composition of claim 1, wherein the rubber polymer is a diene rubber.

9. The composition of claim 1, wherein the rubber polymer is polybutadiene.

10. The composition of claim 1, wherein the composition has an Izod impact strength of between about 1.5 ft.lb/inch and 5.0 ft.lb/inch.

11. The composition of claim 1, wherein the composition has an Izod impact strength of between about 1.8 ft.lb/inch and 2.5 ft.lb/inch.

12. The composition of claim 1, wherein the composition has a tensile elongation of between about 30% and 120%.

13. The composition of claim 1, wherein the composition has a tensile elongation of between about 50% and 90%.

14. The composition of claim 1, wherein the composition has a Vicat heat distortion of between about 205° F. and 220° F.

15. The composition of claim 1, wherein the composition has a Vicat heat distortion of between about 210° F. and 215° F.

16. The composition of claim 1, wherein the composition has a melt flow rate of between about 150 mg/minute and 1500 mg/minute.

17. The composition of claim 1, wherein the composition has a melt flow rate of between about 200 mg/minute and 600 mg/minute.

18. The composition of claim 1, wherein the rubber polymer is polybutadiene and the monoalkenyl aromatic monomer is styrene, the dimer is a styrene dimer, and the trimer is a styrene trimer.

19. The composition of claim 1, wherein the composition comprises about 650 ppm to about 6,500 ppm of the monoalkenyl aromatic dimer.

20. The composition of claim 1, wherein the composition comprises about 650 ppm to about 6,500 ppm of the monoalkenyl aromatic dimer and up to about 14,000 ppm of the monoalkenyl aromatic trimer.

21. The composition of claim 1, wherein the composition comprises less than about 1.0 wt % blowing agent.

22. The composition of claim 1, wherein the composition comprises essentially no blowing agent.

23. A method of preparing a polyblend composition comprising:
polymerizing at least one monoalkenyl aromatic monomer, in the presence of at least one rubber polymer, and (a) at least one monoalkenyl aromatic dimer, (b) at least one monoalkenyl aromatic trimer or (c) a mixture thereof,
wherein the polyblend composition produced comprises a first polymer comprising at least one monoalkenyl aromatic monomer and having a weight average molecular weight (M_{w}) less than about 249,000 amu,
at least one monoalkenyl aromatic dimer, at least one monoalkenyl aromatic trimer, or a mixture thereof, and
at least one rubber polymer, wherein the rubber polymer is dispersed within the first polymer.

24. The method of claim 23, wherein the polyblend composition comprises at least about 650 ppm of the monoalkenyl aromatic dimer.

25. The method of claim 23, wherein the polyblend composition comprises about 650 ppm to about 6,500 ppm of the monoalkenyl aromatic dimer.

26. The method of claim 23, wherein the polyblend composition comprises about 650 ppm to about 6,500 ppm of the monoalkenyl aromatic dimer and up to about 14,000 ppm of the monoalkenyl aromatic trimer.

27. The method of claim 23, wherein the monoalkenyl aromatic dimer, the monoalkenyl aromatic trimer or the mixture thereof are components of a feed stream that comprises between about 0.2 wt % and 3.5 wt % of the monoalkenyl aromatic dimer, the monoalkenyl aromatic trimer, or the mixture thereof.

28. The method of claim 23, wherein the monoalkenyl aromatic dimer, the monoalkenyl aromatic trimer or the mixture thereof are components of a distillate from a second independent polymerization of at least one monoalkenyl aromatic monomer.

29. The method of claim 23, wherein the monoalkenyl aromatic monomer has a formula I 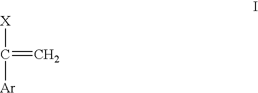
wherein Ar is an aromatic group comprising at least one of a phenyl group, a halo-phenyl group, an alkylphenyl group, or an alkylhalophenyl group, and X is selected from hydrogen or an alkyl radical having less than three carbon atoms.

30. The method of claim 23, wherein the monoalkenyl aromatic monomer is styrene, alpha-methylstyrene, alpha-ethylstyrene, alpha-methylvinyltoluene, vinyl toluene, o-ethylstyrene, p-ethylstyrene, 2,4-dimethylstyrene, t-butylstyrene, o-chlorostyrene, p-chlorostyrene, o-bromostyrene, 2,4-dichlorostyrene, 2-chloro-4-methylstyrene, 2,6-dichloro-4-methylstyrene, or a mixture thereof.

31. The method of claim 23, wherein the monoalkenyl aromatic monomer is styrene.

32. The method of claim 23, wherein the first polymer has a Mw less than about 245,000 amu.

33. The method of claim 23, wherein the first polymer has a Mw between about 220,000 amu and 249,000 amu.

34. The method of claim 23, wherein the rubber polymer is polybutadiene, polyisoprene, poly2-chloro-1,3-butadiene, poly 1-chloro-1,3-butadiene, styrene/butadiene copolymer, styrene/butadiene/styrene block copolymer, ethylene/propylene terpolymer, butadiene/acrylonitrile copolymer, butyl rubber, acrylic rubber, styrene/isobutylene/butadiene copolymer, isoprene/acrylic ester copolymer, or a mixture thereof.

35. The method of claim 23, wherein the rubber polymer is a diene rubber.

36. The method of claim 23, wherein the rubber polymer is polybutadiene.

37. The method of claim 23, wherein the polyblend composition has an Izod impact strength of between about 1.5 ft.lb/inch and 5.0 ft.lb/inch.

38. The method of claim 23, wherein the polyblend composition has a tensile elongation of between about 30% and 120%.

39. The method of claim 23, wherein the polyblend composition has a Vicat heat distortion between about 205° F. and 220° F.

40. The method of claim 23, wherein the polyblend composition has a melt flow rate between about 150 mg/minute and 1500 mg/minute

41. The method of claim 23, wherein the rubber polymer is polybutadiene and the monoalkenyl aromatic monomer is styrene, the dimer is a styrene dimer, and the trimer is a styrene trimer.

42. The method of claim 23, wherein the composition comprises less than about 1.5 wt % blowing agent.

43. The method of claim 23, wherein the composition comprises essentially no blowing agent.

44. A system for production of a polyblend comprising:
a polyblend production vessel,
a first feed line that supplies a first stream comprising (a) at least one dimer of at least one first monoalkenyl aromatic monomer, (b) at least one trimer of at least one first monoalkenyl aromatic monomer, or (c) a mixture thereof to the polyblend production vessel,
a second feed line that supplies a second stream comprising at least one second monoalkenyl aromatic monomer to the polyblend production vessel,
a third feed line that supplies a third stream comprising at least one rubber polymer to the polyblend production vessel, and
a polymerization vessel used in a thermal polymerization of the at least one first monoalkenyl aromatic monomer, wherein the polymerization vessel is coupled to a distillate recovery vessel, and the first feed line connects the distillate recovery vessel to the polyblend production vessel.

45. The system of claim 44, wherein the first stream further comprises toluene or ethyl benzene.

46. The system of claim 44, wherein the first monoalkenyl aromatic monomer and the second monoalkenyl aromatic monomer are the same monomer.

47. The system of claim 44, wherein the first monoalkenyl aromatic monomer and the second monoalkenyl aromatic monomer are styrene.

48. The system of claim 44, wherein the rubber polymer is polybutadiene.

49. The system of claim 44, wherein the rubber polymer is dissolved in a solvent comprising monoalkenyl aromatic monomer.

50. A polyblend composition consisting essentially of:
a first polymer comprising at least one monoalkenyl aromatic monomer and having a weight average molecular weight (M_{w}) less than about 249,000 amu,
at least one monoalkenyl aromatic dimer, at least one monoalkenyl aromatic trimer, or a mixture thereof,
wherein the polyblend composition comprising at least about 650 ppm of the monoalkenyl aromatic dimer, and
at least one rubber polymer, wherein the rubber polymer is dispersed within the first polymer.
